(19) United States
(12) Patent Application Publication
(10) Pub. No.: US 2025/0259298 A1
(43) Pub. Date: Aug. 14, 2025

(54) NORMAL VECTOR SET CREATION APPARATUS, INSPECTION APPARATUS, AND NON-TRANSITORY COMPUTER-READABLE STORAGE MEDIUM

(71) Applicant: KABUSHIKI KAISHA TOSHIBA, Tokyo (JP)

(72) Inventors: Takashi Ida, Kawasaki Kanagawa (JP); Tenta Sasaya, Urayasu Chiba (JP); Toshiyuki Ono, Kawasaki Kanagawa (JP)

(73) Assignee: KABUSHIKI KAISHA TOSHIBA, Tokyo (JP)

(21) Appl. No.: 19/037,660

(22) Filed: Jan. 27, 2025

(30) Foreign Application Priority Data
Feb. 13, 2024 (JP) 2024-019725

(51) Int. Cl. G06T 7/00; G06T 7/155; G06T 7/73; G06V 10/40; G06V 10/74; G06V 10/764; G06V 10/77; G06V 10/776; G06V 10/82; G06V 20/70

(52) U.S. Cl. CPC G06T 7/001; G06T 7/155; G06T 7/74; G06V 10/40; G06V 10/761; G06V 10/764; G06V 10/7715; G06V 10/776; G06V 10/82; G06V 20/70; G06T 2207/20036; G06T 2207/20084; G06T 2207/30141

(57) ABSTRACT

According to one embodiment, a normal vector set creation apparatus generates a feature vector for each position of a normal image by performing feature amount extraction processing using a neural network on the normal image, generates position information indicating whether or not a feature vector at each position of the normal image is an acquisition target by performing image processing on the normal image, selects a feature vector of the acquisition target from among the generated feature vectors based on the position information, and stores the selected feature vector of the acquisition target as a normal vector.

### CROSS-REFERENCE TO RELATED APPLICATION

This application is based upon and claims the benefit of priority from Japanese Patent Application No. 2024-019725, filed Feb. 13, 2024, the entire contents of which are incorporated herein by reference.

### FIELD

Embodiments described herein relate generally to a normal vector set creation apparatus, an inspection apparatus, and a non-transitory computer-readable storage medium.

### BACKGROUND

Up to now, in automatic appearance inspection using a captured image of a manufactured product in a manufacturing factory, it is known that use of a neural network for recognition of the presence or absence of a defect achieves higher recognition accuracy than use of other image processing. Supervised learning of the neural network requires a large number of anomaly images showing defective products and normal images showing non-defective products. However, since the number of anomaly images is particularly small, the number necessary for learning cannot be prepared, and high recognition accuracy cannot be obtained in some cases.

Therefore, in the conventional anomaly detection method, a large amount of general images are collected, and a convolutional neural network trained in advance to recognize a subject in the general images is used. An image is input to the pre-trained neural network, and pixel values at the same position of specific N feature maps generated in the process are arranged in a predetermined order to generate an N-dimensional feature vector for each position of the screen. Anomaly detection in the image is performed using the generated N-dimensional feature vector.

Specifically, first, before the inspection, a normal image in the appearance inspection is input to a pre-trained neural network to generate a feature vector, the feature vector is set as a normal vector, and a set of normal vectors is stored. The normal vector is a value obtained by multiplying the number of image positions by the number of normal images. Then, at the time of inspection, an inspection vector that is a feature vector of the inspection image is generated, a distance between the inspection vector and a normal vector at every position stored as a normal vector set is calculated for each position of the screen, and a minimum value of the distance is set as a score of the position of the inspection image. A score map is obtained by calculating and arranging the scores at all the positions, and if the maximum value is larger than a threshold, it is determined that the inspection image is “anomaly”, and if the maximum value is not larger than the threshold, it is determined that the inspection image is “normal”. The score map can also be used for visual confirmation of an anomaly part by the inspector.

In the anomaly detection method as described above, since the normal vector usually increases, a large amount of memory is required to store the normal vector set. In addition, the inspection requires a large processing amount to calculate the distance between the inspection vector and the normal vector set. In order to reduce the memory amount and the processing amount, it is conceivable to reduce the number of normal images, but the recognition accuracy may deteriorate.

Regarding this, there is a method of selecting and leaving only some normal vectors in the temporarily stored normal vector set. For example, first, a first normal vector is randomly selected. In a next second step, a normal vector farthest from the first selected normal vector is selected. Similarly, unselected normal vectors having the largest distance from the selected vector are sequentially selected, and the selection is terminated at a time when the number of the selected normal vectors reaches a predetermined number. In this way, it is possible to reduce the memory amount of the normal vector set and the processing amount of the inspection without lowering the recognition accuracy too much.

However, the above method requires a large amount of memory for temporarily storing all normal vector sets in advance. Furthermore, in the selection of the normal vectors, it is necessary to calculate the distances between all the selected normal vectors and all the unselected normal vectors for each selection, and a large amount of processing is required. In the reduction of the processing amount, it is also conceivable to calculate and store the distances between all the normal vectors at the time of the first selection, and refer to the stored distances each time the second and subsequent selections are made. However, although the processing amount can be somewhat reduced, an even larger memory amount is required to store the distance. Therefore, it is required to reduce the processing amount and the memory amount related to the normal vector set.

### BRIEF DESCRIPTION OF DRAWINGS

FIG. 1 is a block diagram illustrating a configuration of a normal vector set creation apparatus according to a first embodiment.

FIG. 2 is an illustrative diagram illustrating a feature map and a receptive field in two convolution processes for a normal image in the first embodiment, and a feature vector and a feature vector map.

FIG. 3 is a diagram illustrating a normal image according to the first embodiment.

FIG. 4 is a diagram illustrating a first specific example of a mask image according to the first embodiment.

FIG. 5 is a diagram illustrating a second specific example of the mask image according to the first embodiment.

FIG. 6 is a diagram illustrating a third specific example of the mask image according to the first embodiment.

FIG. 7 is a flowchart illustrating an operation of the normal vector creation apparatus according to the first embodiment.

FIG. 8 is a block diagram illustrating a configuration of an inspection apparatus according to a second embodiment.

FIG. 9 is a flowchart illustrating an operation of the inspection apparatus according to the second embodiment.

FIG. 10 is a flowchart illustrating a first specific example of inspection result output processing in the flowchart of FIG. 9.

FIG. 11 is a diagram illustrating an inspection image showing a defect according to the second embodiment.

FIG. 12 is a diagram illustrating a label map according to the second embodiment.

FIG. 13 is a flowchart illustrating a second specific example of the inspection result output processing in the flowchart of FIG. 9.

FIG. 14 is a block diagram illustrating a hardware configuration of a computer according to an embodiment.

### DETAILED DESCRIPTION

In general, according to one embodiment, a normal vector set creation apparatus generates a feature vector for each position of a normal image by performing feature amount extraction processing using a neural network on the normal image, generates position information indicating whether or not a feature vector at each position of the normal image is an acquisition target by performing image processing on the normal image, selects a feature vector of the acquisition target from among the generated feature vectors based on the position information, and stores the selected feature vector of the acquisition target as a normal vector.

Hereinafter, embodiments of a normal vector set creation apparatus and an inspection apparatus will be described in detail with reference to the drawings.

### First Embodiment

In a first embodiment, creating a normal vector set from a normal image as an input image using a neural network trained in advance will be described. The normal image is assumed to be, for example, a captured image of a manufactured product without a defective portion (disconnection, crack, dirt, and the like of a substrate pattern). In the following specific example, an image of one channel (for example, a grayscale image) will be described as the normal image.

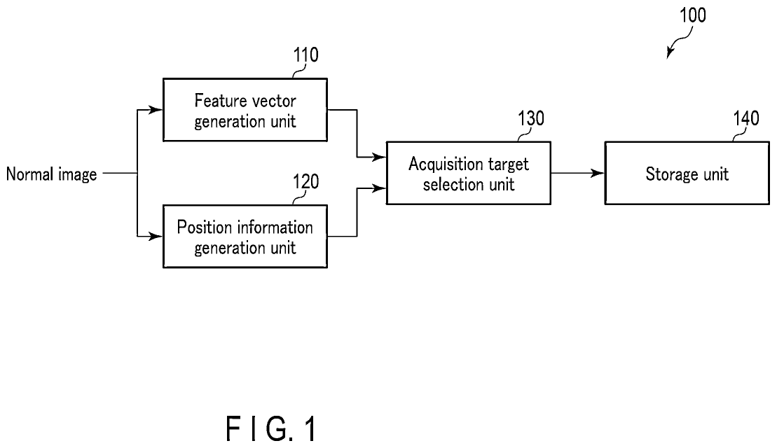

FIG. 1 is a block diagram illustrating a configuration of a normal vector set creation apparatus according to the first embodiment. A normal vector set creation apparatus 100 of FIG. 1 includes a feature vector generation unit 110, a position information generation unit 120, an acquisition target selection unit 130, and a storage unit 140.

Note that the normal vector set creation apparatus 100 may include an acquisition unit that acquires a normal image from another device, a communication unit that communicates with another device, and a control unit that controls each unit of the normal vector set creation apparatus 100.

The feature vector generation unit 110 receives a normal image from another device (not illustrated). The feature vector generation unit 110 generates a feature vector for each position of the normal image by performing feature amount extraction processing using a neural network on the normal image. The feature vector generation unit 110 outputs the generated feature vector to the acquisition target selection unit 130.

The feature amount extraction processing includes convolution processing, activation processing, full connection processing, pooling processing, and the like. Specifically, the feature vector generation unit 110 performs conversion such as convolution processing and activation processing on the normal image, and then converts the normal image into a scalar value by full combination processing, pooling processing, or the like, thereby generating a feature vector in which a plurality of feature amounts is combined for each position of the normal image. The number of feature amounts included in the feature vector may be determined by, for example, the number of times of convolution processing. In other words, the feature vector generation unit 110 includes a neural network that outputs a feature vector by input of a normal image.

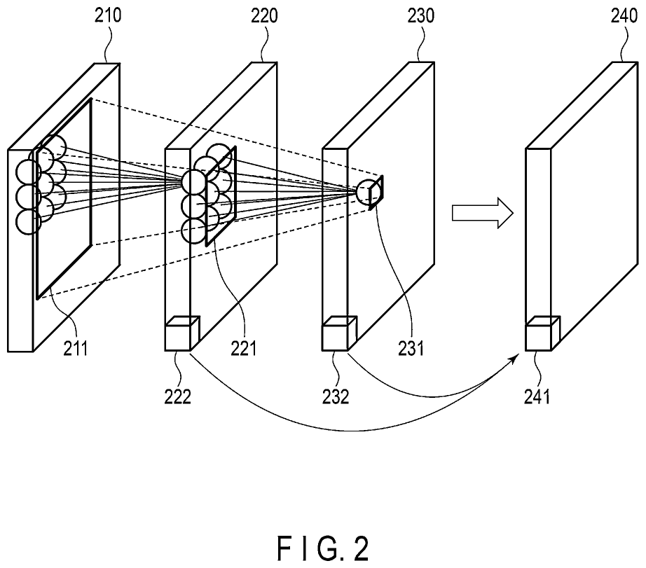

The feature amount extraction processing and the generation of the feature vector will be specifically described with reference to FIG. 2.

FIG. 2 is an illustrative diagram illustrating a feature map and a receptive field in two convolution processes for a normal image in the first embodiment, and a feature vector and a feature vector map. FIG. 2 illustrates an example in which a feature map 220 is generated by performing convolution processing of 3×3 pixels on the normal image 210, and a feature map 230 is generated by similarly performing convolution processing of 3×3 pixels on the feature map 220. Furthermore, FIG. 2 illustrates a feature vector map 240 in which pixel values of the respective feature maps are arranged. Note that illustration of the activation processing, the normalization processing for higher accuracy, and the like is omitted.

The receptive field is a pixel range 221 of the feature map 230 and a pixel range 211 of the normal image 210 that affect one pixel (for example, pixel 231) of the feature map 220. FIG. 2 illustrates an example in which the pixel range 221 is 3×3 pixels and the pixel range 211 is 5×5 pixels. The pixel 231 depends only on the pixel values included in the pixel range 221 and the pixel range 211 that are the receptive field, and thus does not depend on the pixel values other than the receptive field.

Note that, in a case where the size of the feature map 230 and the kernel of the convolution processing (for example, 3×3 pixels) do not change, as the number of times of the convolution processing increases, that is, as the number of convolution layers increases, the pixel range of the receptive field (pixel range 211) of the normal image 210 with respect to the pixel 231 of the feature map 220 becomes wider.

Based on the above, more specific processing will be described. The feature vector generation unit 110 performs zero padding on the normal image 210, and generates the feature map 220 having the same size as the normal image 210 using a stride of one pixel (shift amount of the convolution processing) and the kernel of 3×3 pixels. Then, the feature vector generation unit 110 performs zero padding on the feature map 220 in the same manner as described above, and generates the feature map 230 having the same size as the normal image 210 (or the feature map 220) using the stride of one pixel and the kernel of 3×3 pixels.

After generating the feature map 220 and the feature map 230, the feature vector generation unit 110 generates the feature vector 241 by arranging the pixel values of the feature map 220 and the feature map 230 at the same position (the pixel 222 of the feature map 220 and the pixel 232 of the feature map 230). In the example of FIG. 2, the feature map 220 and the feature map 230 each have one channel. Therefore, the dimension of the feature vector 241 is two-dimensional. Note that the feature vector generation unit 110 may generate a feature vector map 240 in which a feature vector is associated with each position of the normal image 210.

Note that the feature map 220 and the feature map 230 may include two or more channels by using kernels of parameters (for example, different weighting factors) different for each channel. In a case where the feature map includes two or more channels, the dimension of the feature vector 241 is the sum of the number of channels of the feature map 220 and the number of channels of the feature map 230. In addition, the generation of the feature vector does not necessarily use all the feature maps, and the feature vector generation unit 110 may generate the feature vector using only a predetermined specific feature map.

The position information generation unit 120 receives a normal image from another device (not illustrated). The position information generation unit 120 performs image processing on the normal image to generate position information indicating whether or not the feature vector at each position of the normal image is to be acquired. The image processing is, for example, processing of calculating variance of surrounding pixel values with respect to the position of interest. For example, the position information generation unit 120 generates position information indicating that the feature vector is set as the acquisition target in a case where the variance is larger than a threshold and the feature vector is not set as the acquisition target in a case where the variance is equal to or smaller than the threshold. In other words, the position information generation unit 120 generates the position information in which the position of the non-flat portion of the normal image is set as the feature vector acquisition target. The position information generation unit 120 outputs the generated position information to the acquisition target selection unit 130.

For example, the position information may indicate whether or not each position of the normal image is the acquisition target with a numerical value (for example, a pixel value). Furthermore, the position information may be, for example, a mask image having the same size as the normal image, or an array of coordinate information indicating each position of the normal image. The numerical value may be a binary value (for example, “0” and “1”).

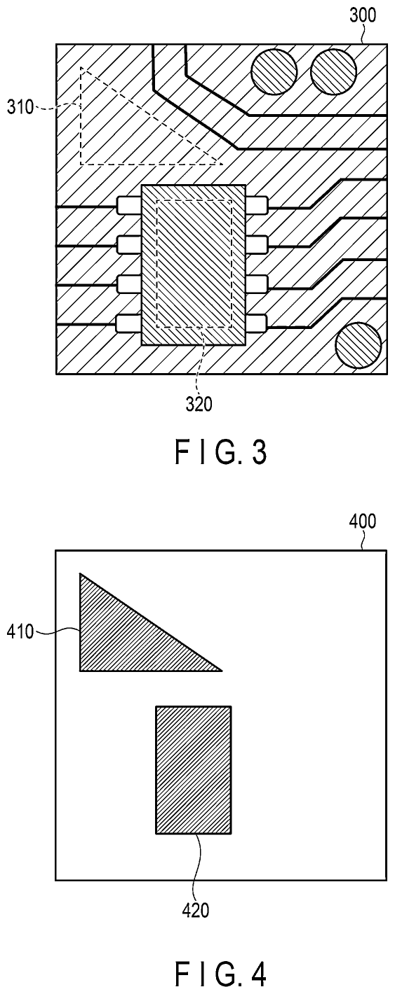

The normal image and the mask image will be specifically described with reference to FIGS. 3 to 6.

FIG. 3 is a diagram illustrating a normal image according to the first embodiment. A normal image 300 in FIG. 3 is a captured image of a manufactured product (substrate) without a defective portion. In the normal image 300, a flat region 310 and a flat region 320 in which variance of pixel values is small are illustrated. Next, a first specific example in which the flat region 310 and the flat region 320 are masked will be described.

FIG. 4 is a diagram illustrating a first specific example of a mask image in the first embodiment. The mask image 400 in FIG. 4 has the same size as the normal image 300, and a portion of the normal image 300 where the variance of the pixel values is small is represented by black (for example, the pixel value “0”), and a region where the variance of the pixel values is large is represented by white (for example, the pixel value “255”). In the mask image 400, a mask region 410 and a mask region 420 having a small variance of pixel values are illustrated. The mask region 410 and the mask region 420 correspond to the flat region 310 and the flat region 320 of FIG. 3.

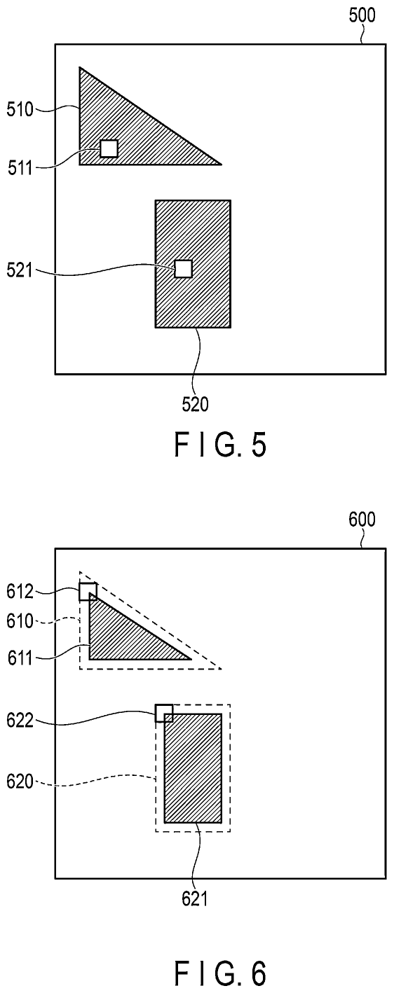

Next, a second specific example of acquiring a partial region from each of the mask region 410 and the mask region 420 and a third specific example of eroding the mask region 410 and the mask region 420 will be described with reference to FIGS. 5 and 6, respectively.

FIG. 5 is a diagram illustrating a second specific example of the mask image in the first embodiment. A mask image 500 in FIG. 5 has the same size as that of the normal image 300, and in the normal image, a portion having a small variance of pixel values is represented in black, and a region having a large variance of pixel values is represented in white. In the mask image 500, a mask region 510 and a mask region 520 having a small variance of pixel values are illustrated. The mask region 510 and the mask region 520 correspond to the flat region 310 and the flat region 320 of FIG. 3.

Furthermore, the mask region 510 and the mask region 520 include a non-mask region 511 and a non-mask region 521, respectively. The non-mask region 511 and the non-mask region 521 are regions intentionally selected from the mask region 510 and the mask region 520. Since the non-mask region 511 and the non-mask region 521 are provided, the feature vector to be acquired increases, but the feature vector of the flat portion can also be considered, so that the reliability of the inspection result can be improved in the inspection apparatus to be described later.

FIG. 6 is a diagram illustrating the third specific example of the mask image in the first embodiment. A mask image 600 in FIG. 6 has the same size as that of the normal image 300, and in the normal image, a portion having a small variance of pixel values is represented in black, and a region having a large variance of pixel values is represented in white. In the mask image, a mask region 611 and a mask region 621 having a small variance of pixel values are illustrated. The mask region 611 and the mask region 621 are regions eroded more than the original mask region 610 (corresponding to the mask region 410) and the mask region 620 (corresponding to the mask region 420).

The erosion of the mask region as described above is related to the receptive field in the feature amount extraction processing. For example, when attention is paid to the feature vectors at arbitrary two positions in the mask region 610, it is conceivable that a non-flat portion is included in the receptive field of the normal image in the generation of one feature vector, and only a flat portion is included in the receptive field of the normal image in the generation of the other feature vector. In view of this, these two feature vectors may have different values, which may affect the reliability of the inspection result.

Therefore, in order to reduce the above influence, the position information generation unit 120 performs erosion processing in the morphology operation on the regions (the original mask region 610 and the original mask region 620) that are not to be acquired in the mask image 600, thereby generating the mask region 611 and the mask region 621 in which the regions are eroded. For this reason, the mask image 600 may be referred to as an erosion processed mask image. The erosion processing is performed, for example, according to a half width of the receptive field 612 (or the receptive field 622) of the mask region 610 (or the mask region 620). Note that the receptive field 612 and the receptive field 622 correspond to, for example, either the pixel range 211 or the pixel range 221 in FIG. 2.

As described above, the mask region is narrowed along an outer periphery thereof, so that the third specific example can improve the reliability of the inspection result in the inspection apparatus to be described later, similarly to the second specific example.

The acquisition target selection unit 130 receives the feature vector from the feature vector generation unit 110 and receives the position information from the position information generation unit 120. The acquisition target selection unit 130 selects a feature vector to be acquired from among the generated feature vectors on the basis of the position information. The acquisition target selection unit 130 outputs the selected acquisition target feature vector to the storage unit 140.

Specifically, in a case where the position information is the mask image, the acquisition target selection unit 130 selects a feature vector to be acquired on the basis of the mask image. More specifically, the acquisition target selection unit 130 does not select the feature vector corresponding to the mask region in the mask image, but selects the feature vector corresponding to the other region.

The storage unit 140 receives the feature vector of the acquisition target selected from the acquisition target selection unit 130. The storage unit 140 stores the selected acquisition target feature vector as a normal vector. Note that the feature vectors generated with respect to all the acquisition target positions of the normal image may be referred to as a feature vector set.

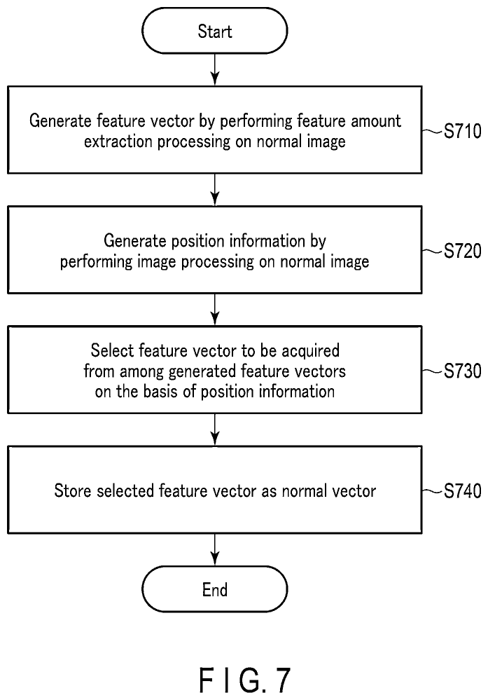

The configuration and the like of the normal vector set creation apparatus according to the first embodiment have been described above. Next, an operation of the normal vector set creation apparatus according to the first embodiment will be described with reference to FIG. 7.

FIG. 7 is a flowchart illustrating an operation of the normal vector creation apparatus according to the first embodiment. The flowchart of FIG. 7 illustrates a series of flow of normal vector set creation processing for the input normal image.

### Step S710

When the normal vector set creation processing is started and the normal vector set creation apparatus 100 acquires a normal image, the feature vector generation unit 110 generates a feature vector by performing feature amount extraction processing on the normal image. Specifically, the feature vector generation unit generates a feature vector for each position of the normal image by performing the feature amount extraction processing using a neural network on the normal image.

### Step S720

After the feature vector is generated, the position information generation unit 120 generates the position information by performing image processing on the normal image. Specifically, the position information generation unit 120 performs image processing on the normal image to generate position information indicating whether or not the feature vector at each position of the normal image is to be acquired.

### Step S730

After the position information is generated, the acquisition target selection unit 130 selects a feature vector to be acquired from among the generated feature vectors on the basis of the position information.

### Step S740

After the feature vector to be acquired is selected, the storage unit 140 stores the selected feature vector as a normal vector. After step S740, the normal vector set creation processing ends.

As described above, the normal vector set creation apparatus according to the first embodiment performs the feature amount extraction processing using the neural network on the normal image to generate the feature vector for each position of the normal image, performs the image processing on the normal image to generate the position information indicating whether or not the feature vector at each position of the normal image is to be acquired, selects the feature vector of the acquisition target from the generated feature vectors on the basis of the position information, and stores the selected feature vector to be acquired as the normal vector.

Therefore, since the normal vector set creation apparatus according to the first embodiment can determine the feature vector to be acquired only by performing image processing on the normal image, it is not necessary to thin out the feature vector in a vector space, and the processing amount can be reduced. In addition, since the normal vector set creation apparatus according to the first embodiment does not acquire a feature vector that is not to be acquired (does not affect inspection), it is not necessary to store an unnecessary feature vector, and thus, it is possible to reduce the memory amount for storing the normal vector set.

### Second Embodiment

In the first embodiment, the normal vector set creation apparatus that creates a normal vector set has been described. On the other hand, in a second embodiment, an inspection apparatus that outputs an inspection result related to an anomaly of an inspection image as an input image using a normal vector set created by a normal vector set creation apparatus will be described. The inspection image is assumed to be, for example, a captured image of the same manufactured product as the manufactured product of the normal image of the first embodiment. In the following specific example, an image of one channel (for example, a grayscale image) is assumed as the inspection image.

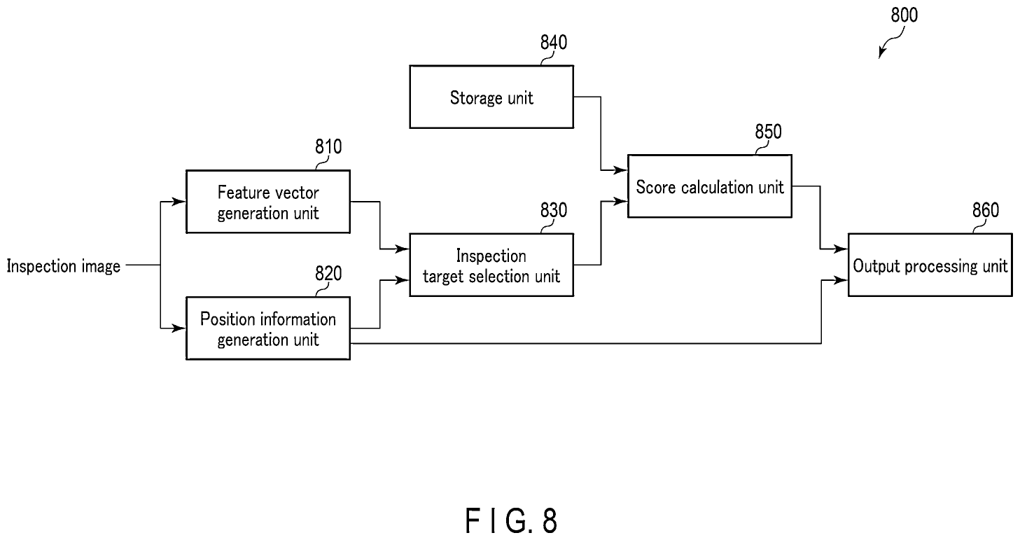

FIG. 8 is a block diagram illustrating a configuration of the inspection apparatus according to the second embodiment. An inspection apparatus 800 in FIG. 8 includes a feature vector generation unit 810, a position information generation unit 820, an inspection target selection unit 830, a storage unit 840, a score calculation unit 850, and an output processing unit 860.

Note that the inspection apparatus 800 may include an acquisition unit that acquires an inspection image from another device, a communication unit that communicates with another device, and a control unit that controls each unit of the inspection apparatus 800.

The feature vector generation unit 810 receives an inspection image from another device (not illustrated). The feature vector generation unit 810 generates a feature vector for each position of the inspection image by performing feature amount extraction processing using a neural network on the inspection image. The feature vector generation unit 810 outputs the generated feature vector to the inspection target selection unit 830. Note that the configuration of the feature vector generation unit 810 is similar to that of the feature vector generation unit 110 of the first embodiment, and thus a specific description thereof will be omitted. A neural network used in the feature vector generation unit 810 has the same configuration and the same parameters as those of the neural network used in the feature vector generation unit 110.

The position information generation unit 820 receives an inspection image from another device (not illustrated). The position information generation unit 820 performs image processing on the inspection image to generate position information indicating whether or not a feature vector at each position of the inspection image is to be inspected. The position information generation unit 820 outputs the generated position information to the inspection target selection unit 830 and the output processing unit 860. Note that other configurations of the position information generation unit 820 are similar to those of the position information generation unit 120 of the first embodiment, and thus a specific description thereof will be omitted. The image processing of the position information generation unit 820 uses the same algorithm as that of the image processing of the position information generation unit 120. With use of the same algorithm as that of the image processing of the position information generation unit 120, the position information generation unit 820 can improve the reliability of the inspection result since the statistical distribution of the feature vectors becomes close.

The inspection target selection unit 830 receives the feature vector from the feature vector generation unit 810 and receives the position information from the position information generation unit 820. The inspection target selection unit 830 selects a feature vector to be inspected from among the generated feature vectors on the basis of the position information. The inspection target selection unit 830 outputs the selected feature vector of the inspection target to the score calculation unit 850. Since the configuration of the inspection target selection unit 830 is similar to that of the acquisition target selection unit 130 of the first embodiment, a specific description thereof will be omitted.

The storage unit 840 stores the normal vector in the normal vector set creation apparatus according to the first embodiment. The storage unit 840 outputs the stored normal vector (alternatively, a normal vector set) to the score calculation unit 850. Note that the storage unit 840 of the first embodiment may be used as it is as the storage unit 140.

The score calculation unit 850 receives the feature vector of the inspection target from the inspection target selection unit 830 and receives the normal vector from the storage unit 840. The score calculation unit 850 calculates a score based on the distance between the feature vector to be inspected and the normal vector. Specifically, the score calculation unit 850 calculates the distance between the feature vector to be inspected and all the normal vectors stored in the storage unit 840, and sets the minimum value of the distances as the score. The score calculation unit 850 outputs the calculated score to the output processing unit 860.

The output processing unit 860 receives the position information from the position information generation unit 820 and receives the score from the score calculation unit 850. The output processing unit 860 outputs the inspection result regarding the anomaly of the inspection image on the basis of the position information and the score. The inspection result may be, for example, a label map including a label based on a score or a score map including a score. Both the label map and the score map have the same size as that of the inspection image. The inspection result may include information indicating the presence or absence of anomaly in the inspection image. Furthermore, the output processing unit 860 may output a superimposed image obtained by superimposing the inspection image and the score map as the inspection result.

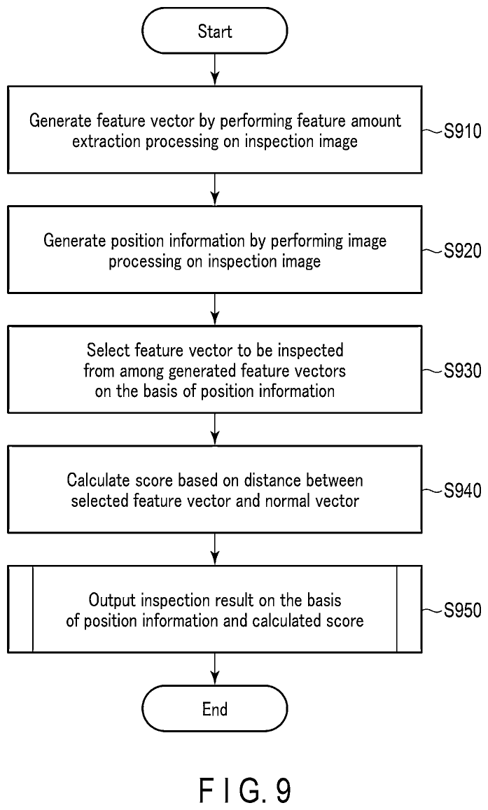

FIG. 9 is a flowchart illustrating an operation of the inspection apparatus according to the second embodiment. The flowchart of FIG. 9 illustrates a series of flow of the inspection processing on the input inspection image.

### Step S910

When the inspection processing is started and the inspection apparatus 800 acquires the inspection image, the feature vector generation unit 810 generates the feature vector by performing the feature amount extraction processing on the inspection image. Specifically, the feature vector generation unit 810 generates a feature vector for each position of the inspection image by performing feature amount extraction processing using a neural network on the inspection image.

### Step S920

After the feature vector is generated, the position information generation unit 820 generates position information by performing image processing on the inspection image. Specifically, the position information generation unit 820 performs image processing on the inspection image to generate position information indicating whether or not a feature vector at each position of the inspection image is to be inspected.

### Step S930

After the position information is generated, the inspection target selection unit 830 selects the feature vector to be inspected among the generated feature vectors on the basis of the position information.

### Step S940

After the feature vector to be inspected is selected, the score calculation unit 850 calculates a score based on the distance between the selected feature vector and the normal vector.

### Step S950

After the score is calculated, the output processing unit 860 outputs the inspection result on the basis of the position information and the calculated score. Specifically, the output processing unit 860 outputs the inspection result regarding the anomaly of the inspection image on the basis of the position information and the calculated score. After step S950, the inspection processing ends.

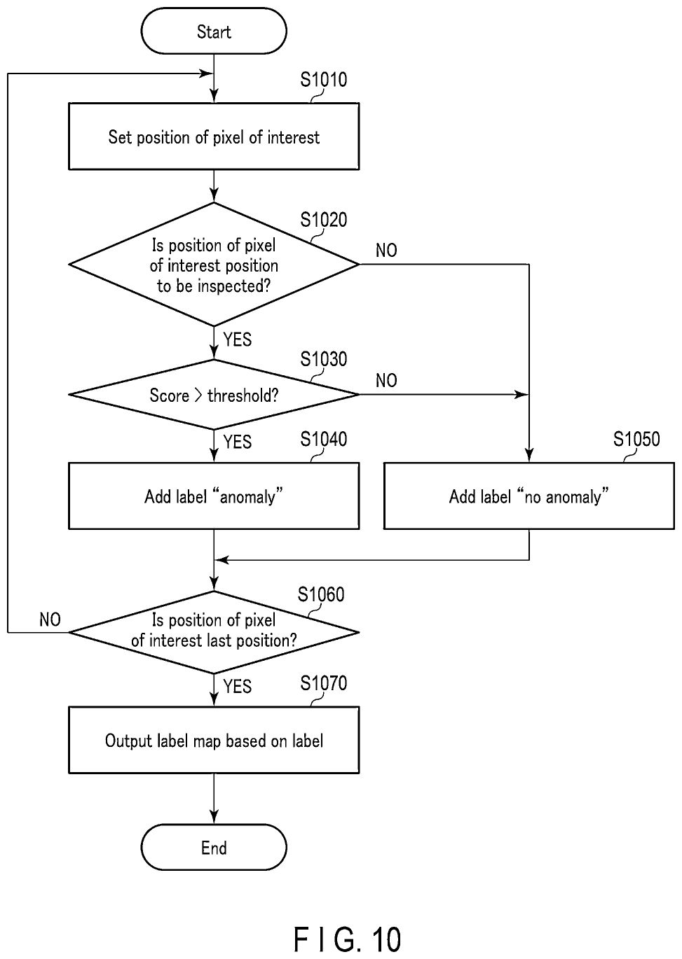

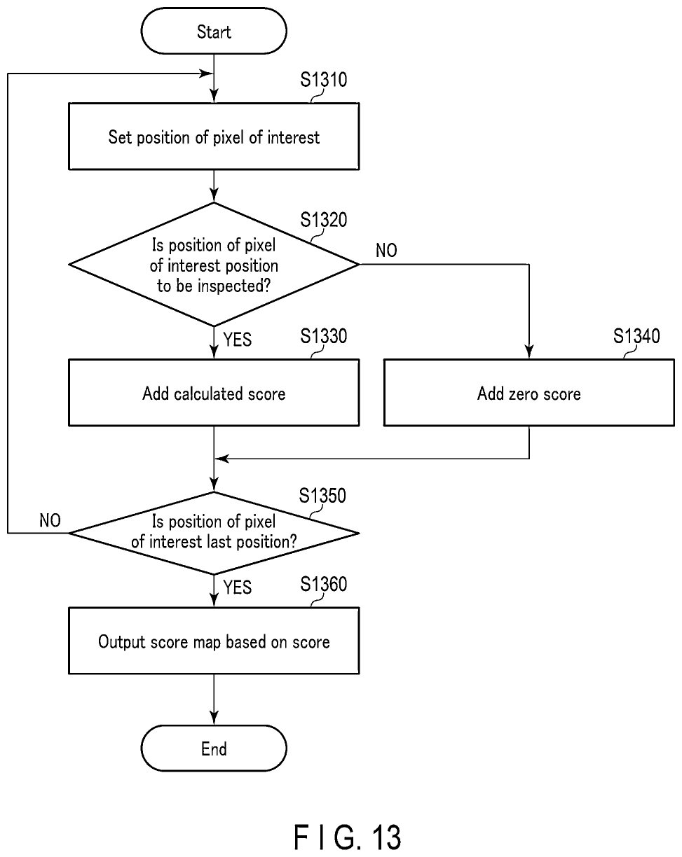

The processing in step S950 may be referred to as “inspection result output processing”. A first specific example and a second specific example of the inspection result output processing will be described with reference to flowcharts of FIGS. 10 and 13, respectively.

### First Specific Example of Inspection Result Output Processing

FIG. 10 is a flowchart illustrating a first specific example of the inspection result output processing of the flowchart of FIG. 9. In the first specific example, a label map is generated as an inspection result. The flowchart of FIG. 10 transitions from step S940 of the flowchart of FIG. 9.

### Step S1010

When the inspection result output processing is started, the output processing unit 860 sets the position of a pixel of interest. Specifically, in the first setting, the output processing unit 860 sets the upper left of the screen as the position of the pixel of interest. In the case of the second and subsequent settings, the output processing unit 860 sets an unset position as the position of the pixel of interest in a predetermined order (for example, raster scan order).

### Step S1020

After setting the position of the pixel of interest, the output processing unit 860 determines whether or not the position of the pixel of interest is the position of the inspection target on the basis of the position information. Specifically, the output processing unit 860 determines that the position of the pixel of interest is the position of the inspection target in a case where the position of the pixel of interest is included in a region other than the mask region in the mask image, and determines that the position of the image of interest is not the position of the inspection target in a case where the position of the pixel of interest is included in the mask region in the mask image. In a case where it is determined that the position of the pixel of interest is the position of the inspection target, the processing proceeds to step S1030. In a case where it is determined that the position of the pixel of interest is not the position of the inspection target, the processing proceeds to step S1050.

### Step S1030

After determining that the position of the pixel of interest is the position of the inspection target, the output processing unit 860 determines whether or not the score calculated for the feature vector corresponding to the position of the pixel of interest is larger than a threshold. In a case where it is determined that the score is larger than the threshold, the processing proceeds to step S1040. In a case where it is determined that the score is equal to or less than the threshold, the processing proceeds to step S1050.

### Step S1040

After determining that the score is larger than the threshold, the output processing unit 860 adds a label “anomaly” (anomaly label) to the position of the pixel of interest. After step S1040, the processing proceeds to step S1060.

### Step S1050

After it is determined in step S1020 that the position of the pixel of interest is not the position of the inspection target, or after it is determined in step S1030 that the score is equal to or less than the threshold, the output processing unit 860 adds the label “no anomaly” (non-anomaly label) to the position of the pixel of interest. After step S1050, the processing proceeds to step S1060.

### Step S1060

After adding a label to the position of the pixel of interest, the output processing unit 860 determines whether or not the position of the pixel of interest is a last position. The last position is, for example, the lower right position of a screen in a case where the upper left of the screen is first set as the position of the pixel of interest and then the position of the pixel of interest is set in the order of raster scanning. In a case where it is determined that the position of the pixel of interest is the last position, the processing proceeds to step S1070. In a case where it is determined that the position of the pixel of interest is not the last position, the processing returns to step S1010.

### Step S1070

After determining that the position of the pixel of interest is the last position, the output processing unit 860 outputs a label map based on the labels added for all the positions corresponding to the inspection image. After step S1070, the inspection result output processing ends.

A first specific example of the inspection result output processing will be briefly described. The output processing unit 860 adds a label with anomaly indicating presence of anomaly to the position of the pixel of interest corresponding to the position of the inspection image in a case where the score for the feature vector of the inspection target is larger than the threshold, adds a label without anomaly indicating absence of anomaly to the position of the pixel of interest in a case where the pixel of interest is not the inspection target and the score for the feature vector of the inspection target is equal to or less than the threshold, and outputs a label map having the same size as that of the inspection image including at least one of the label with anomaly and the label without anomaly as the inspection result.

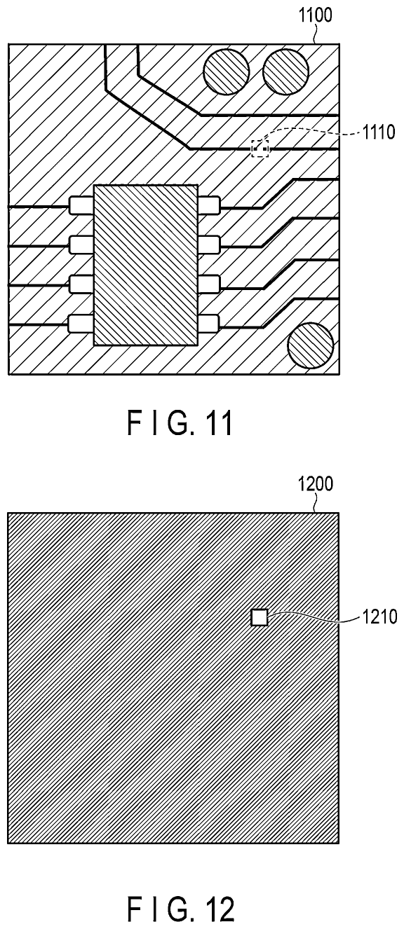

Hereinafter, a defective inspection image and a label map corresponding to the inspection image will be described with reference to FIGS. 11 and 12.

FIG. 11 is a diagram illustrating an inspection image showing a defect according to the second embodiment. An inspection image 1100 of FIG. 11 is substantially similar to the normal image 300 of FIG. 3, but includes a defect region 1110 with disconnection of a substrate pattern. The inspection apparatus 800 executes the inspection processing and the inspection result output processing on the inspection image 1100 to add the anomaly label to the position corresponding to the defect region 1110 of the inspection image 1100.

FIG. 12 is a diagram illustrating an example of the label map in the second embodiment. A label map 1200 of FIG. 12 has the same size as that of the inspection image 1100, and includes an anomaly label 1210 at the same position as the defect region 1110 of the inspection image 1100. In the label map 1200, the region of the anomaly label 1210 is represented in white (for example, the pixel value “255”), and the other region (region of the non-anomaly label) is represented in black (for example, the pixel value “0”). Therefore, a user (inspector) can immediately find the defect region of the inspection image 1100 by visually recognizing the label map 1200.

### Second Specific Example of Inspection Result Output Processing

FIG. 13 is a flowchart illustrating a second specific example of the inspection result output processing of the flowchart of FIG. 9. In the second specific example, a score map is generated as an inspection result. The flowchart of FIG. 13 transitions from step S940 of the flowchart of FIG. 9.

### Step S1310

When the inspection result output processing is started, the output processing unit 860 sets the position of a pixel of interest. Since a specific setting method is similar to step S1010 of the flowchart of FIG. 10, the description thereof is omitted.

### Step S1320

After setting the position of the pixel of interest, the output processing unit 860 determines whether or not the position of the pixel of interest is the position of the inspection target on the basis of the position information. Since a specific determination method is similar to step S1020 in the flowchart of FIG. 10, the description thereof will be omitted. In a case where it is determined that the position of the pixel of interest is the position of the inspection target, the processing proceeds to step S1330. In a case where it is determined that the position of the pixel of interest is not the position of the inspection target, the processing proceeds to step S1340.

### Step S1330

After determining that the position of the pixel of interest is the position of the inspection target, the output processing unit 860 adds the score calculated for the feature vector corresponding to the position of the pixel of interest to the position of the pixel of interest. After step S1330, the processing proceeds to step S1350.

### Step S1340

After determining that the position of the pixel of interest is not the position of the inspection target in step S1320, the output processing unit 860 adds a score of zero to the position of the pixel of interest.

### Step S1350

After adding the score to the position of the pixel of interest, the output processing unit 860 determines whether or not the position of the pixel of interest is the last position. Since a specific determination method is similar to step S1060 in the flowchart of FIG. 10, the description thereof will be omitted. In a case where it is determined that the position of the pixel of interest is the last position, the processing proceeds to step S1360. In a case where it is determined that the position of the pixel of interest is not the last position, the processing returns to step S1310.

### Step S1360

After determining that the position of the pixel of interest is the last position, the output processing unit 860 outputs the score map based on the scores added for all the positions corresponding to the inspection image. After step S1360, the inspection result output processing ends.

A second specific example of the inspection result output processing will be briefly described. The output processing unit 860 adds a calculated score in a case where the position of the pixel of interest corresponding to the position of the inspection image is the inspection target, adds a score of zero in a case where the position is not the inspection target, and outputs a score map having the same size as the inspection image including at least one of the calculated score and the score of zero as the inspection result.

As described above, the inspection apparatus according to the second embodiment generates the feature vector for each position of the inspection image by performing the feature amount extraction processing using the neural network on the inspection image, generates the position information indicating whether or not the feature vector at each position of the inspection image is the inspection target by performing the image processing on the inspection image, selects the feature vector of the inspection target from the generated feature vectors on the basis of the position information, stores the normal vector in the normal vector set creation apparatus according to the first embodiment, calculates the score based on the distance between the selected feature vector of the inspection target and the normal vector, and outputs the inspection result regarding the anomaly of the inspection image on the basis of the position information and the score.

Therefore, since the inspection apparatus according to the second embodiment can determine the feature vector of the inspection target only by performing image processing on the inspection image, it is not necessary to perform unnecessary score calculation, and the processing amount can be reduced. In addition, since the inspection apparatus according to the second embodiment can omit the score calculation regarding the feature vector that is not the inspection target (does not affect the inspection result), it is possible to maintain the reliability of the inspection result while reducing the processing amount.

### Another Specific Example of Normal Image and Inspection Image

In each of the above embodiments, the description has been given assuming the normal image and the inspection image of one channel (these are collectively referred to as input images). However, the input image may be an RGB color image. In a case where the input image is a color image, the feature vector generation unit 110 and the feature vector generation unit 810 treat one input image as three images having the same number of vertical and horizontal pixels of the Red component, the Green component, and the Blue component, that is, images of three channels. In this case, the feature vector generation unit 110 and the feature vector generation unit 810 use a three-dimensional kernel such as 3×3 pixels×3 channels. In addition, the feature vector generation unit 110 and the feature vector generation unit 810 may perform convolution processing three or more times in the feature amount extraction processing.

### Another Specific Example of Mask Image

In the first embodiment described above, three specific examples of FIGS. 4 to 6 have been described for the mask image. All of these three specific examples focus on the flat portion of the image. However, the mask region of the mask image is not limited to the flat portion, and may be set using, for example, the following fourth specific example, fifth specific example, and sixth specific example. Hereinafter, each specific example will be described by either the processing in the normal vector creation apparatus or the processing in the inspection apparatus, but is not limited to the described apparatus.

In the fourth specific example, the mask region is set using pattern matching. For example, the normal vector creation apparatus performs pattern matching in the input image (normal image), determines that parts having a small pattern matching error have the same pattern, and sets only one of the parts as a feature vector acquisition target. As a result, the normal vector creation apparatus can avoid acquisition of feature vectors having similar feature amounts.

In the fifth specific example, the mask area is set in consideration of the characteristics of the imaging device that acquires the inspection image. There is a case where an image end of the inspection image is distorted due to distortion of refraction in a lens of an imaging device. In such a case, the inspection apparatus sets a central region of the captured image as an acquisition target of the feature vector. As a result, the inspection apparatus can avoid the decrease in reliability of the inspection result due to the addition of the low-quality image to the normal vector, and can reduce the memory amount by reducing the number of normal vectors.

In the sixth specific example, a mask region is set in advance in consideration of a region requiring no inspection. For example, in the inspection processing in a manufacturing factory, a component or the like that does not need to be inspected may be shown in an image. In such a case, the inspection apparatus acquires a feature vector at a position where a component to be inspected is captured in advance. As a result, the inspection apparatus does not need to wastefully capture the information of the component that does not need to be inspected into the normal vector set, and can reduce the memory amount while maintaining the reliability of the inspection result.

The six specific examples described above may

be appropriately combined and used.

### Hardware Configuration

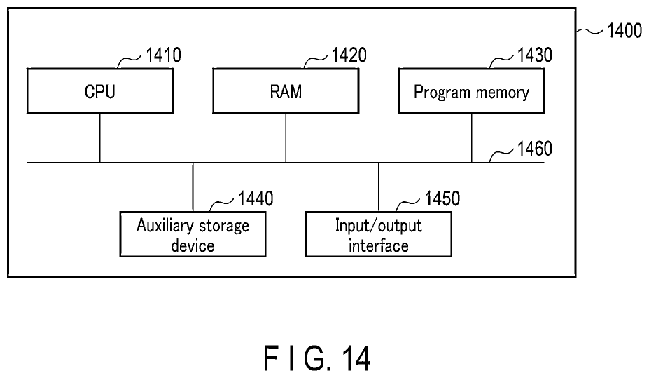

FIG. 14 is a block diagram illustrating a hardware configuration of a computer according to an embodiment. A computer 1400 in FIG. 14 includes, as hardware, a central processing unit (CPU) 1410, a random access memory (RAM) 1420, a program memory 1430, an auxiliary storage device 1440, and an input/output interface 1450.

The CPU 1410 communicates with the RAM 1420,

the program memory 1430, the auxiliary storage device 1440, and the input/output interface 1450 through a bus 1460.

The CPU 1410 is an example of a general-purpose processor. The RAM 1420 is used as a working memory for the CPU 1410. The RAM 1420 includes a volatile memory such as a synchronous dynamic random access memory (SDRAM). The program memory 1430 stores various programs including a program related to normal vector set creation processing (normal vector set creation program) or a program related to inspection processing (inspection program). As the program memory 1430, for example, a read-only memory (ROM), a part of the auxiliary storage device 1440, or a combination thereof is used. The auxiliary storage device 1440 non-temporarily stores data. The auxiliary storage device 1440 includes a nonvolatile memory such as an HDD or an SSD.

The input/output interface 1450 is an interface for connecting to another device. The input/output interface 1450 is used for connection with another device, for example.

Each program stored in the program memory 1430 includes a computer-executable instruction. When executed by the CPU 1410, the program (computer-executable instruction) causes the CPU 1410 to execute predetermined processing. For example, when executed by the CPU 1410, the normal vector set creation program, the inspection program, and the like cause the CPU 1410 to execute a series of processing described with respect to each unit of FIGS. 1 and 8.

The program may be provided to the computer 1400 in a state of being stored in a computer-readable storage medium. In this case, for example, the computer 1400 further includes a drive (not illustrated) that reads data from the storage medium, and acquires the program from the storage medium. Examples of the storage medium include a magnetic disk, an optical disk (CD-ROM, CD-R, DVD-ROM, DVD-R, and the like), a magneto-optical disk (MO or the like), and a semiconductor memory. In addition, the program may be stored in a server on the communication network, and the computer 1400 may download the program from the server using the input/output interface 1450.

The processing described in the embodiment is not limited to being performed by a general-purpose hardware processor such as the CPU 1410 executing a program, and may be performed by a dedicated hardware processor such as an application specific integrated circuit (ASIC). The term processing circuit (processing unit) includes at least one general purpose hardware processor, at least one special purpose hardware processor, or a combination of at least one general purpose hardware processor and at least one special purpose hardware processor. In the example illustrated in FIG. 14, the CPU 1410, the RAM 1420, and the program memory 1430 correspond to a processing circuit.

Therefore, according to each of the above embodiments, the processing amount and the memory amount related to the normal vector set can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A normal vector set creation apparatus comprising processing circuitry configured to:
generate a feature vector for each position of a normal image by performing feature amount extraction processing using a neural network on the normal image;
generate position information indicating whether or not a feature vector at each position of the normal image is an acquisition target by performing image processing on the normal image;
select a feature vector of the acquisition target from among the generated feature vectors based on the position information; and
store the selected feature vector of the acquisition target as a normal vector.

2. The normal vector set creation apparatus according to claim 1, wherein
the neural network includes a plurality of convolution layers,
the feature amount extraction processing is convolution processing of generating a feature map having the same size as that of the normal image, and
the feature vector is obtained by arranging pixel values at the same position of the feature map generated from the convolution layers.

3. The normal vector set creation apparatus according to claim 2, wherein the processing circuitry is further configured to generate the position information that numerically indicates whether or not a feature vector at each position of the normal image is the acquisition target.

4. The normal vector set creation apparatus according to claim 3, wherein the position information is a mask image having the same size as that of the normal image, and the processing circuitry is further configured to select the feature vector of the acquisition target based on the mask image.

5. The normal vector set creation apparatus according to claim 4, wherein the processing circuitry is further configured to:
generate an erosion processed mask image in which a region, that is not the acquisition target in the mask image, has been eroded by performing erosion processing in a morphology operation on the region; and
select the feature vector of the acquisition target based on the erosion processed mask image.

6. The normal vector set creation apparatus according to claim 5, wherein the erosion processing is performed according to a width of a half of a receptive field of the mask image.

7. The normal vector set creation apparatus according to claim 3, wherein the position information is an array of coordinate information indicating each position of the normal image.

8. The normal vector set creation apparatus according to claim 1, wherein the processing circuitry is further configured to generate the position information in which a position of a non-flat portion of the normal image is set as the acquisition target of the feature vector.

9. The normal vector set creation apparatus according to claim 1, wherein the image processing is processing of calculating variance of surrounding pixel values with respect to a position of interest, and the processing circuitry is further configured to generate the position information with a region in which the variance is larger than a threshold as the acquisition target.

10. The normal vector set creation apparatus according to claim 1, wherein the processing circuitry is further configured to generate, in a case where there is a plurality of same image patterns in the normal image, the position information in which a position corresponding to at least one image pattern is set as an acquisition target of the feature vector.

11. The normal vector set creation apparatus according to claim 1, wherein the processing circuitry is further configured to generate the position information in which a region specified in advance in the normal image is set as the acquisition target of the feature vector.

12. An inspection apparatus comprising processing circuitry configured to:
generate a feature vector for each position of an inspection image by performing feature amount extraction processing using a neural network on the inspection image;
generate position information indicating whether or not a feature vector at each position of the inspection image is an inspection target by performing image processing on the inspection image;
select a feature vector of the inspection target from among the generated feature vectors based on the position information;
store the normal vector in the normal vector set creation apparatus according to claim 1;
calculate a score based on a distance between the selected feature vector of the inspection target and the normal vector; and
output an inspection result related to an anomaly of the inspection image based on the position information and the score.

13. The inspection apparatus according to claim 12, wherein the inspection result includes information indicating presence or absence of anomaly in the inspection image.

14. The inspection apparatus according to claim 12, wherein the processing circuitry is further configured to:
add an anomaly label indicating presence of anomaly in a case where the score for the feature vector of the inspection target is larger than a threshold;
add a non-anomaly label indicating no anomaly in a case where the feature vector is not the inspection target and in a case where the score for the feature vector of the inspection target is equal to or less than the threshold; and
output, as the inspection result, a label map including at least one of the anomaly label and the non-anomaly label and having the same size as that of the inspection image,
with respect to a position of a pixel of interest corresponding to a position of the inspection image.

15. The inspection apparatus according to claim 12, wherein the processing circuitry is further configured to:
add the calculated score in the case of the inspection target;
add a score of zero in a case of no inspection target; and
output, as the inspection result, a score map having the same size as that of the inspection image, the score map including at least one of the calculated score and the score of zero,
with respect to a position of a pixel of interest corresponding to a position of the inspection image.

16. The inspection apparatus according to claim 15, wherein the processing circuitry is further configured to output a superimposed image obtained by superimposing the inspection image and the score map as the inspection result.

17. The inspection apparatus according to claim 15, wherein the inspection result further includes information indicating presence or absence of anomaly in the inspection image, and the processing circuitry is further configured to compare each score of the score map with a threshold, and output the inspection result including information indicating that there is anomaly in the inspection image in a case where there is a score larger than the threshold.

18. The inspection apparatus according to claim 12, wherein the image processing uses the same algorithm as that of image processing related to position information generation in the normal vector set creation apparatus.

19. The inspection apparatus according to claim 12, wherein the neural network has the same configuration and the same parameters as those of a neural network used in the normal vector set creation apparatus.

20. A non-transitory computer-readable storage medium storing a program for causing a computer to execute processing comprising:
generating a feature vector for each position of a normal image by performing feature amount extraction processing using a neural network on the normal image;
generating position information indicating whether or not a feature vector at each position of the normal image is an acquisition target by performing image processing on the normal image;
selecting a feature vector of an acquisition target from among the generated feature vectors based on the position information; and
storing the selected feature vector of the acquisition target as a normal vector.
